(19) United States
(12) Patent Application Publication
(10) Pub. No.: US 2003/0115117 A1
(43) Pub. Date: Jun. 19, 2003

(54) Method and system for displaying commodity characteristics on a screen

(76) Inventor: Mika Sugimoto, Asaka-shi (JP)

Correspondence Address: BIRCH STEWART KOLASCH & BIRCH, PO BOX 747, FALLS CHURCH, VA, 22040-0747, US

(21) Appl. No.: 10/315,132

(22) Filed: Dec. 10, 2002

(30) Foreign Application Priority Data
Dec. 10, 2001 (JP) 2001-375872

(51) Int. Cl. G06F 17/60

(52) U.S. Cl. 705/27

(57) ABSTRACT

The purpose of the present invention is to realize a system and a method to understand the difference in the characteristics of commodities which cannot be understood intuitively only by way of a display of numerical values, by associating such a difference with the travel speed of the commodity and the mouse pointer and as different arrangement on the screen. The present invention provides a method for displaying the characteristics of a commodity to purchase on a screen in the Internet shopping where commodities and services are purchased on the Internet. This method changes the display related to the selected commodity based on the numerical information indicating the characteristics of the commodity such as a price and a weight in selection of the commodity. For example, the distance between the image of the selected commodity and the mouse pointer is changed.

### BACKGROUND OF THE INVENTION

1. Field of the Invention

The present invention relates to a method and a system for displaying commodity characteristics, which an user wants to buy or is interested in, on a screen by way of the Graphical User Interface (GUI) display which allows intuitive understanding of the magnitude of numerical values representing the characteristics of a commodity such as a price, a weight, a volume and a delivery date of a commodity, in purchasing the commodity on an Internet shopping site.

2. Description of the Related Art

In recent years, so-called Internet shopping has a problem that the operator tends to make an expensive purchase easily because a simple click-and-drag operation can purchase a commodity. That is, in Internet shopping, various commodities having different commodity characteristics such as price and size can be purchased easily with same operation. This makes it difficult to intuitively understand the characteristics of a commodity in the purchase of the commodity.

Recent progress in the research and development of virtual reality has proposed technologies whereby the operator can simulate the shape, size, weight and feel of an object in a virtual space through senses of sight, hearing and touch. It is expected that the operator will more intuitively recognize the numerical values representing characteristics of a commodity including non-physical volumes such as a higher/lower price of the target commodity, as well as physical volumes, through for example an experience of virtual payment. However, this approach requires extra equipment such as a special display and actuator, which is disadvantageous in terms of cost and equipment arrangement.

### SUMMARY OF THE INVENTION

The invention has been proposed in view of the aforementioned circumstances and aims at providing a method for displaying commodity characteristics on a screen and a system for displaying commodity characteristics on a screen which help the operator intuitively understand the characteristics of a commodity by associating different characteristics of the commodity difficult to understand only via numerical values, such as price and size, with the travel speed of the image of the commodity and the mouse pointer as well as different arrangement on the screen.

In order to solve the problem, a method for displaying commodity characteristics on a screen according to the first aspect of the invention displays the characteristics of a commodity to purchase on a screen in the Internet shopping where commodities and services are purchased on the Internet, characterized in that the method comprises a step of controlling the commodity characteristics display for changing the display related to a selected commodity based on the numerical value information indicating the characteristics of the commodity such as a price and a weight in selection of commodities.

A system for displaying commodity characteristics on a screen according to the fifth aspect of the invention displays the characteristics of a commodity to purchase on a screen in the Internet shopping where commodities and services are purchased on the Internet, characterized in that the system comprises commodity characteristics display control means for changing the display related to a selected commodity based on the numerical value information indicating the characteristics of the commodity such as a price and a weight in selection of commodities.

The commodity characteristics display control includes, in particular, changing the travel speed of the image indicating a selected commodity and the mouse pointer (second and sixth aspects), changing the distance between the image indicating the selected commodity and the mouse pointer (third and seventh aspects), and one of the different types of voice guidance is output simultaneously with the screen display in accordance with the travel speed of the image indicating the selected commodity and the mouse pointer (fourth and eighth aspects).

According to this configuration, it is possible to visually represent the characteristics of the commodity such as the price and size of the commodity via GUI display by changing the drag speed in dragging the image of a selected commodity. This allows the operator or purchaser of the commodity to intuitively understand the characteristics of the target commodity. By increasing or decreasing the interval between the commodity image and the mouse pointer, the operator is able to intuitively understand the characteristics of the target commodity.

### BRIEF DESCRIPTION OF THE DRAWINGS

FIG. 1 is a schematic diagram showing a screen display example assumed when the home page of an Internet shopping site is operated in a system for displaying commodity characteristics on a screen according to an embodiment of the invention;

FIG. 2 is a block diagram showing the system configuration according to an embodiment of the invention;

FIG. 3 is a flowchart showing a procedure to execute screen display control of a system for displaying commodity characteristics on a screen according to an embodiment of the invention;

FIGS. 4A and 4B are schematic drawings showing the change in the interval between the mouse pointer and the commodity image in accordance with the numerical values indicating the characteristics of a commodity by using a rubber band in a system for displaying commodity characteristics on a screen according to an embodiment of the invention; and

FIGS. 5A and 5B are schematic drawings showing the change in the interval between the mouse pointer and the commodity image in accordance with the numerical values indicating the characteristics of a commodity by using a spring in a system for displaying commodity characteristics on a screen according to an embodiment of the invention.

In the figures, a reference numeral 1 refers to a control section; 2 to a memory; 3 to a display; 4 to a speaker; 5 to a pointing device; 6 to a communications interface; 7 to an Internet; 8 to a web server; 10 to a commodity list; 11 to an image of a diamond ring; 12 to an image of a handbag; 13 to a shopping cart; 14 to a mouse pointer; 15 to a rubber band; 16 to a spring; and 100 to a personal computer.

### DETAILED DESCRIPTION OF THE PREFERRED EMBODIMENTS

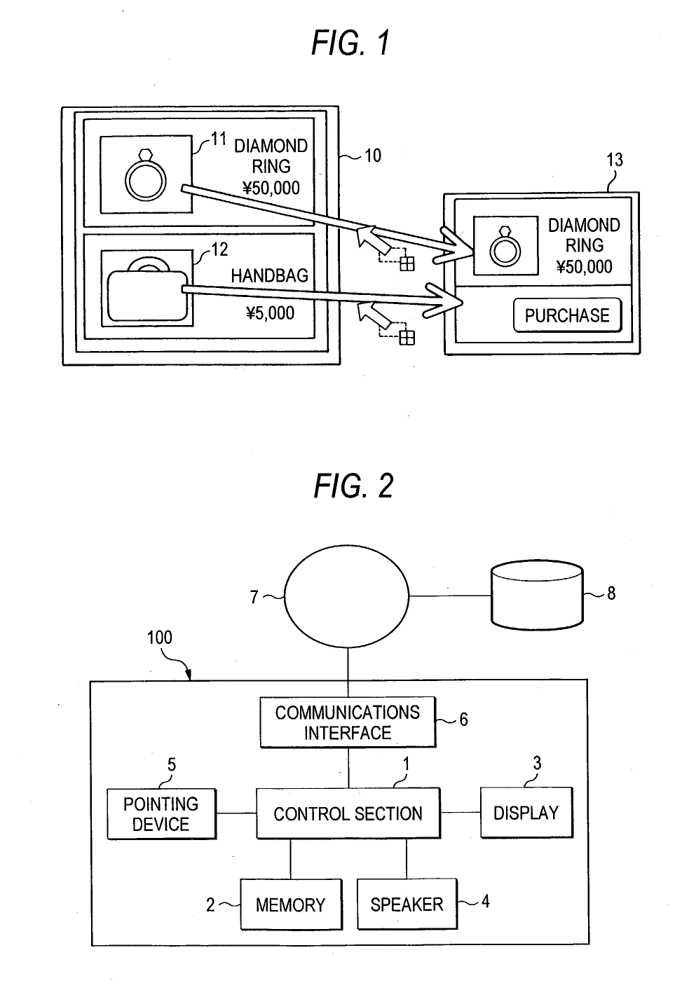

An embodiment of the invention will be described. FIG. 1 is a schematic diagram showing a screen display example assumed when the home page of an Internet shopping site is operated in a system for displaying commodity characteristics on a screen according to an embodiment of the invention. In this embodiment, purchase of a commodity is made by clicking on the image of the target commodity in the commodity list on the left of the screen and dragging the image to a shopping cart. In this example, the drag speed of the image of the commodity to purchase and the interval between the image of the commodity and the mouse pointer are changed in accordance with a higher/lower price of the commodity. Details of display change will be given later.

First, a configuration to implement the screen display will be described. FIG. 2 is a block diagram showing the system configuration according to this embodiment. A personal computer 100 (hereinafter referred to as PC) mainly comprises a control section 1, a memory 2, a display 3, a speaker 4, a pointing device 5 and a communications interface 6, and is connected to a web server 8 via the Internet 7.

The control section 1 comprises a CPU and a controller. The control section 1, connected to the memory 2, the display 3, the speaker 4, the pointing device 5 and the communications interface 6, controls the operation of the entire system. In the memory 2 are stored programs serving as commodity characteristics display control means and other programs as well as data. The programs serving as commodity characteristics display control means are those controlling screen display and voice output in response to operations such as dragging on a web browser and application. The display 3 displays the GUI screen used for a web browser and application as well as home pages of Internet shopping and comprises a CRT and an LCD display. The speaker 4 is used for voice output. The pointing device is for example a mouse and is used for various input operations. The communications interface 6 controls Internet connection to a web server.

The programs as commodity characteristics display control means are preferably in the form of plug-in software downloaded from a web server to a PC during an access to the web server or a subprogram in application software. For example, a program written using the onclick function of JavaScript in an HTML file may be downloaded from a web server for later execution.

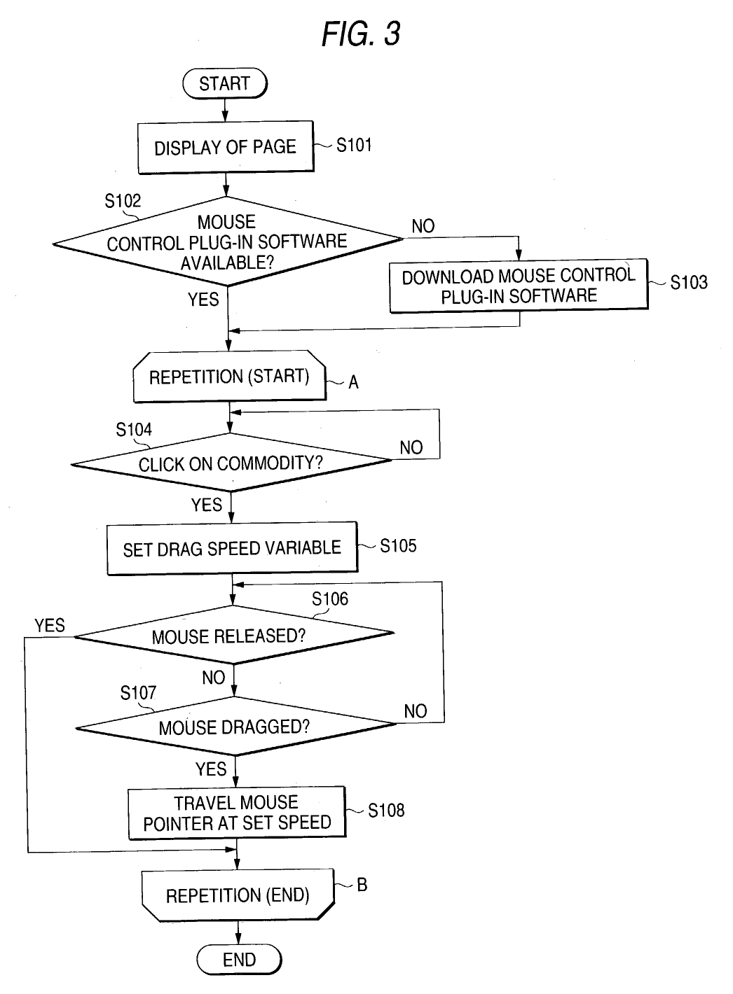

Next, a procedure for executing the screen display control will be described using the flowchart of FIG. 3. Here, a program to control the travel speed of the mouse pointer will be described, not the image of a commodity. First, a PC is started to display the home page of an Internet shopping site (step S101). It is determined whether there is a program to control the travel speed of the mouse pointer (step S102) on the PC. In case there is no such a program, an appropriate program is downloaded (step S103). Then, the procedure waits for a click on the image of a commodity (step S104). When a click is made on an image, a predetermined drag speed variable is set depending on the price of the selected commodity (step S105). Release of the mouse is determined (step S106). In case the mouse is not released, a drag is determined (step S107). In case a drag is performed, the mouse pointer is traveled at the set drag speed (step S108). Otherwise, execution returns to determination of mouse release (step S106). In case release of the mouse is detected in step S106, execution proceeds to the position B in the flowchart. The section in the flowchart starting with A and ending with B is repeated as long as the mouse is clicked and dragged, so that the mouse pointer travels at a predetermined speed in relation to the mouse operation.

A specific action in the screen example of FIG. 1 will be described. A commodity list 10 shows an image 11 of a diamond ring priced at 50000 yen and an image 12 of a handbag priced at 5000 yen. While the example shows the state the image 11 of the diamond ring is dragged to a shopping cart 13, a lower travel speed of a commodity image and the mouse pointer is preset in the program according to this embodiment in case the image of a commodity at 10000 yen or higher is dragged. Thus, the travel speed of the commodity and the mouse pointer assumed when the image 11 of the diamond ring priced at 50000 yen is dragged is slower than the actual operation speed of the mouse. The handbag is priced at 5000 yen, so that the travel speed of the commodity and the mouse pointer assumed when the image 12 of the handbag is dragged is the same as the actual operation speed of the mouse.

By decreasing the drag speed and showing that the selected commodity is heavy, the operator (purchaser of the commodity) can recognize that the commodity is high priced. The operator recognizes that a commodity with higher drag speed is less expensive or low-priced. Such drag speed levels can be preset. For example, two levels of drag speed, for a case where the price exceeds an arbitrary threshold and a case where the price does not. Alternatively, three or more levels of drag speeds can be set by providing a plurality of price thresholds. A price threshold may be arbitrarily set through special manipulation on the screen by the operator.

A synthetic tone, such as a dragging and heavy low tone in case the drag speed is low and a light high tone in case the drag speed is high, may be generated from the speaker 4 of the PC to the screen display in dragging, so as to help the operator recognize a higher or lower price by the sense of hearing as well.

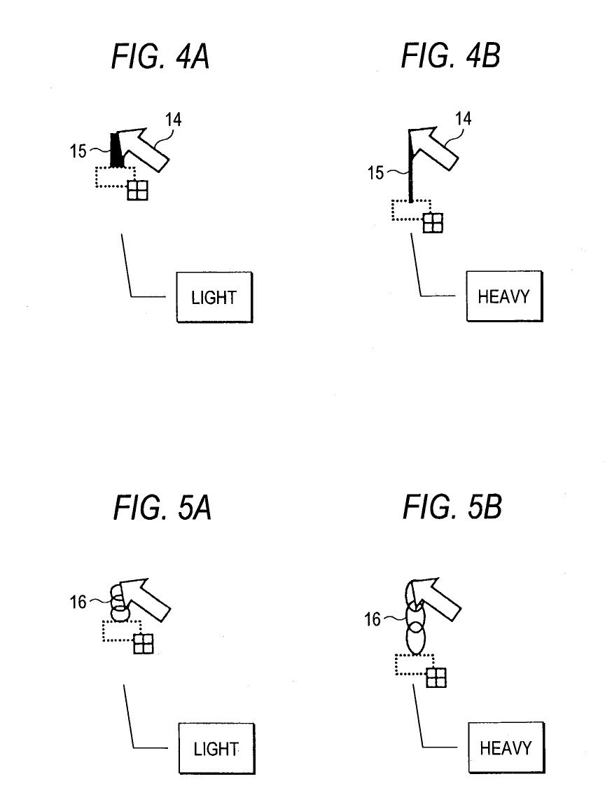

In this embodiment, when the image of a commodity is clicked and dragged, the interval between the mouse pointer and the image of the commodity changes depending on the price of the commodity. FIGS. 4A and 4B show examples of such display and the image of the commodity is suspended with a rubber band 15 from a muse pointer 14. A higher or lower price is associated with a heavier or lighter weight. A commodity at a high price is shown as a heavy one and the rubber band is elongated. A commodity at a low price is shown as a light one and the rubber band stays short.

For example, assuming the same threshold value, a commodity priced at below 10000 yen is shown in FIG. 4A while a commodity priced at 10000 or above is shown in FIG. 4B. This recognizes that greater elongation of the rubber band corresponds to a high commodity. In this case likewise, the threshold of price (type of elongation of rubber band) may be arbitrarily set by the operator (purchaser of the commodity) also.

Setting is also allowed to execute this display only by moving the mouse pointer over an arbitrary image in the commodity list 10 without click operation.

As shown in FIGS. 5A and 5B, a spring 16 may be used instead of a rubber band to represent elongation and shrinkage.

While a display control program as commodity characteristics display control means is downloaded from a web server in the embodiment, an application program stored on a recording medium such as a CD-ROM may be loaded and a display control program may be called therefrom.

The setting of drag speed, rubber band and spring is applicable on a page programmed so that the operator's double-click on the image of a commodity will automatically move the image of the commodity to a shopping cart, without the operator having to drag the commodity image to the shopping cart.

While a PC is used as a system component in this embodiment, the invention is not limited to this but any device may be used so long as the device is an information terminal where a web browser and an application may be executed and a pointing device such as a mouse may be installed or connected. The source code of a program as commodity characteristics display control means is not limited to HTML.

Finally, while the difference in the travel speed and elongation of a rubber band or spring corresponds to a higher/lower price of a commodity in this embodiment, such a difference may be associated with numerical values showing the other characteristics of the commodity. For example, elongation of a rubber band or spring may be associated with the weight and volume of a commodity. The travel speed of the image of a commodity and the mouse pointer may be associated with a term required to deliver the commodity. For example, a lower speed may be used in case it take time to deliver the commodity. In case the commodity may be shipped right away, a high speed may be used. This allows the operator to recognize various characteristics of a commodity in a qualitative and intuitive manner.

In the foregoing description, an image of a commodity includes a photograph of the commodity and an illustration, an icon, a text or any other display intended to represent the commodity.

it is possible to visually represent the characteristics of the commodity such as the price and size of the commodity via GUI display by changing the drag speed in dragging the image of a selected commodity. This allows the operator or purchaser of the commodity to intuitively understand the characteristics of the target commodity.

What is claimed is:

1. A method for displaying commodity characteristics on a screen utilized in an Internet shopping where commodities and services are purchased on the Internet, said method comprising the step of:
controlling the commodity characteristics display for changing the display related to a selected commodity based on the numerical value information indicating the characteristics of the commodity such as a price and a weight in selection of commodities.

2. The method for displaying commodity characteristics on a screen according to claim 1,
wherein, in said step of controlling the commodity characteristics display, a travel speed of an image indicating the selected commodity and a travel speed of a mouse pointer are changed.

3. The method for displaying commodity characteristics on a screen according to claim 1,
wherein, in said step of controlling the commodity characteristics display, a distance between the image indicating the selected commodity and the mouse pointer is changed.

4. The method for displaying commodity characteristics on a screen according to claim 2,
wherein, in said step of controlling the commodity characteristics display, one of the different types of voice guidance is output simultaneously with the screen display in accordance with the travel speed of said image indicating the selected commodity and the mouse pointer.

5. A system for displaying commodity characteristics on a screen utilized in an Internet shopping where commodities and services are purchased on the Internet, said system comprising:
commodity characteristics display control means for changing the display related to a selected commodity based on the numerical value information indicating the characteristics of the commodity such as a price and a weight in selection of commodities.

6. The system for displaying commodity characteristics on a screen according to claim 5,
wherein said commodity characteristics display control means changes the travel speed of the image indicating a selected commodity and the mouse pointer.

7. The system for displaying commodity characteristics on a screen according to claim 5,
characterized in that said commodity characteristics display control means changes the distance between the image indicating the selected commodity and the mouse pointer.

8. The system for displaying commodity characteristics on a screen according to claim 6,
wherein one of the different types of voice guidance is output simultaneously with the screen display in accordance with the travel speed of the image indicating said selected commodity and the mouse pointer.
